(19) United States
(12) Patent Application Publication
(10) Pub. No.: US 2023/0388892 A1
(43) Pub. Date: Nov. 30, 2023

(54) BASE STATION AND METHOD FOR SUPPORTING SELF-CONFIGURATION AND SELF-OPTIMIZATION

(71) Applicant: Samsung Electronics Co., Ltd., Suwon-si (KR)

(72) Inventors: Lixiang XU, Beijing (CN); Weiwei WANG, Beijing (CN); Hong WANG, Beijing (CN)

(21) Appl. No.: 18/325,580

(22) Filed: May 30, 2023

(30) Foreign Application Priority Data
May 30, 2022 (CN) 202210605812.3
Aug. 3, 2022 (CN) 202210927347.5
Feb. 21, 2023 (CN) 202310181824.2

(51) Int. Cl. H04W 36/36; H04W 36/00; H04W 76/20

(52) U.S. Cl. CPC H04W 36/362; H04W 36/008375; H04W 76/20

(57) ABSTRACT

The disclosure relates to a 5G or 6G communication system for supporting a higher data transmission rate. A base station and a method for supporting self-configuration and self-optimization are provided. The method includes sending, by a main node (MN), a secondary node (SN) addition request message to a target candidate SN, receiving, by the MN, an addition request acknowledgment message from the target candidate SN, sending, by the MN, a radio resource control (RRC) reconfiguration message to a user equipment (UE), receiving, by the MN, an RRC reconfiguration complete message from the UE, which is an RRC reconfiguration complete message sent by the UE after accessing a candidate secondary cell group primary cell (PS Cell), sending, by the MN, an SN release request message to a source SN, receiving, by the MN, an SN release request acknowledgment message from the source SN, wherein the release request acknowledgment message includes secondary cell group (SCG) UE history information, updating, by the MN, saved UE history information, sending, by the MN, UE history information to a target SN.

### CROSS-REFERENCE TO RELATED APPLICATION(S)

This application is based on and claims priority under 35 U.S.C. § 119(a) of a Chinese patent application number 202210605812.3, filed on May 30, 2022, in the Chinese Intellectual Property Office, of a Chinese patent application number 202210927347.5, filed on Aug. 3, 2022, in the Chinese Intellectual Property Office, and of a Chinese patent application number 202310181824.2, filed on Feb. 21, 2023, in the Chinese Intellectual Property Office, the disclosure of each of which is incorporated by reference herein in its entirety.

### BACKGROUND

### 1. Field

The disclosure relates to wireless communication technology. More particularly, the disclosure relates to a base station and a method for supporting self-configuration and self-optimization.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of fourth generation (4G) communication system, efforts have been made to develop an improved 5G or pre-5G communication system. Therefore, the 5G or pre-5G communication system is also called “beyond 4G network” or “post long term evolution (LTE) system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The above information is presented as background information only to assist with an understanding of the disclosure. No determination has been made, and no assertion is made, as to whether any of the above might be applicable as prior art with regard to the disclosure.

### SUMMARY

For the enhanced mobility solution, how to support robustness in mobility during the handover process is a problem that needs to be solved at present.

Aspects of the disclosure are to address at least the above-mentioned problems and/or disadvantages and to provide at least the advantages described below. Accordingly, an aspect of the disclosure is to provide a method for supporting self-configuration and self-optimization of the disclosure that supports the problem of ping-pong in the enhanced mobility process, correctly save the time UE stayed in the source cell or the source secondary cell group primary cell (PSCell) cell, and correctly associate the information of the primary cell (PCell) and PSCells, which can avoid misjudgment caused by inaccurate UE history information in the prior art, ensure the correctness of UE history information during conditional handover (CHO) and conditional PSCell change (CPC) process, so as to carry out reasonable optimization to ensure the normal operation of the system.

Additional aspects will be set forth in part in the description which follows and, in part, will be apparent from the description, or may be learned by practice of the presented embodiments.

In accordance with an aspect of the disclosure, a method for self-configuration and self-optimization is provided. The method includes a source base station sending a handover request message to a candidate target base station to request conditional handover (CHO), the source base station receiving a handover request acknowledgment message from the candidate target base station, the source base station sending a radio resource control (RRC) reconfiguration message to a UE, the source base station receiving a handover success message from a target base station, the source base station sending UE history information to the target base station.

Optionally, the source base station can send the UE history information to the target base station through a sequence number SN status transfer message. The source base station can also send UE history information to the target base station through other messages.

Optionally, the method also includes the following steps:
the target base station receives the UE history information, and the target base station updates the saved UE history information.

Optionally, the source base station sends the information of the source cell in the UE history information to the target base station.

Optionally, the source base station sends the time UE stayed in the source cell to the target base station.

In accordance with another aspect of the disclosure, a method for self-configuration and self-optimization is provided. The method includes a target base station receives a handover request message from a source base station, and the handover request message requests CHO, the target base station sends a handover request acknowledgment message to the source base station, the target base station receives an RRC reconfiguration complete message from a UE, the target base station updates saved UE history information.

Optionally, the target base station updates the time UE stayed in the source cell in the saved UE history information.

Optionally, the time UE stayed in the source cell is the time UE stayed in the source cell saved by the target base station plus a time duration from receiving the handover request message to receiving the RRC reconfiguration complete message by the target base station, or the time UE stayed in the source cell is the time UE stayed in the source cell saved by the target base station plus a time duration from receiving the handover request message by the target base station to UE synchronization to the target cell.

In accordance with another aspect of the disclosure, a method for self-configuration and self-optimization is provided. The method includes a master node (MN) sending a secondary node (SN) addition request message to a target candidate SN, the MN receiving an addition request acknowledgment message from the target candidate SN, the MN sending an RRC reconfiguration message to a UE, the MN receiving an RRC reconfiguration complete message from the UE, which is an RRC reconfiguration complete message sent by the UE after accessing a candidate secondary cell group primary cell (PSCell), the MN sending an SN release request message to a source SN, the MN receiving an SN release request acknowledgment message from the source SN, wherein the release request acknowledgment message includes secondary cell group (SCG) UE history information, the MN updating saved UE history information, the MN sending UE history information to the target SN.

Optionally, the MN updates the UE history information according to the SCG UE history information received from the SN release request message or the time UE stayed in a PSCell included in the SCG UE history information.

Optionally, the MN updates the saved UE history information according to the time when receiving RRC reconfiguration from the UE.

Optionally, the MN can send UE history information to the target SN through SN reconfiguration complete. The MN can also send UE history information to the target SN through SN status transfer or other messages.

Optionally, it also includes the following steps the target SN overwrites the previously saved UE history information with the received UE history information.

In accordance with another aspect of the disclosure, a target base station in a mobile communication system is provided. The target base station includes a transceiver for transmitting/receiving signals to/from other network entities, and a controller that controls the overall operation of the target base station, wherein the target base station is configured to perform the above method performed by the target base station.

In accordance with another aspect of the disclosure, a source base station in a mobile communication system is provided. The source base station includes a transceiver for transmitting/receiving signals to/from other network entities, and a controller that controls the overall operation of the source base station, wherein the source base station is configured to perform the above-mentioned method performed by the source base station.

With the method and base station for supporting self-configuration and self-optimization, misjudgment caused by inaccurate UE history information in the prior art can be avoided, and the correctness of UE history information in the process of CHO and CPC can be ensured, so as to carry out reasonable optimization and ensure the normal operation of the system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a system architecture of System Architecture Evolution (SAE) according to an embodiment of the disclosure;

FIG. 2 is a system architecture according to an embodiment of the disclosure;

FIG. 3 shows a flowchart of method 1 for supporting self-configuration and self-optimization according to an embodiment of the disclosure;

FIG. 4 shows a flowchart of method 2 for supporting self-configuration and self-optimization according to an embodiment of the disclosure;

FIG. 5 shows a flowchart of method 3 for supporting self-configuration and self-optimization according to an embodiment of the disclosure;

FIG. 6 shows a flowchart of method 4 for supporting self-configuration and self-optimization according to an embodiment of the disclosure;

FIG. 7 shows a schematic diagram of an embodiment of method 1 for supporting self-configuration and self-optimization according to an embodiment of the disclosure;

FIG. 8 shows a schematic diagram of an embodiment of the method 2 for supporting self-configuration and self-optimization according to an embodiment of the disclosure;

FIG. 9 shows a schematic diagram of an embodiment of method 3 for supporting self-configuration and self-optimization according to an embodiment of the disclosure;

FIG. 10 shows a schematic diagram of an embodiment of method 4 for supporting self-configuration and self-optimization according to an embodiment of the disclosure;

FIG. 11 shows a block diagram of a target base station according to an embodiment of the disclosure; and

FIG. 12 shows a block diagram of a source base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

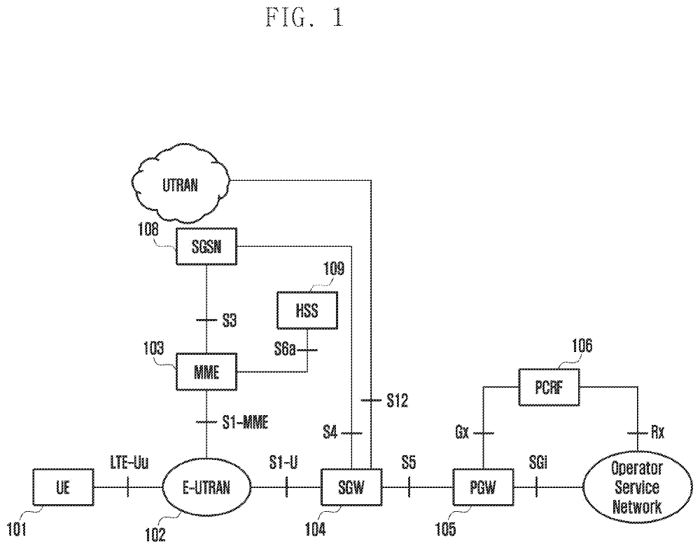

FIGS. 1 to 12 discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

FIG. 1 is a system architecture 100 of system architecture evolution (SAE) according to an embodiment of the disclosure.

Referring to FIG. 1, user equipment (UE) 101 is a terminal device for receiving data. An evolved universal terrestrial radio access network (E-UTRAN) 102 is a radio access network, which includes a macro base station (evolved node B (eNodeB)/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

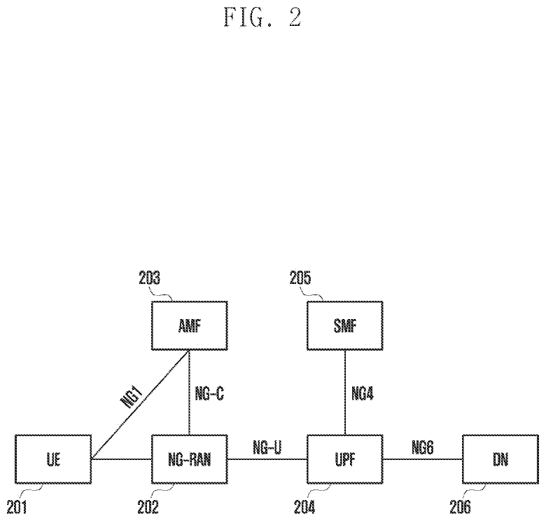

FIG. 2 is a system architecture 200 according to an embodiment of the disclosure. Other embodiments of the system architecture 200 can be used without departing from the scope of the disclosure.

Referring to FIG. 2, user equipment (UE) 201 is a terminal device for receiving data. A next generation radio access network (NG-RAN) 202 is a radio access network, which includes a base station (a next generation node B (gNB) or an evolved node B (eNB) connected to 5G core network 5G core (5GC), and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity session management function (SMF) 205 is responsible for session management. A data network (DN) 206 includes, for example, services of operators, access of Internet and service of third parties.

When a UE moves between two base stations, in order to improve the reliability of handover, conditional handover (CHO) is defined in 3rd generation partnership project (3GPP) release 16. In order to increase the reliability of the dual connectivity process, the conditional secondary cell group primary cell (PSCell) addition (CPA) and conditional PSCell change (CPC) processes are defined in 3GPP.

There are still some problems about how to support self-configuration and self-optimization during the process of CHO, CPA and CPC. For example, for CHO, during the handover preparation process, the source base station sends UE history information to the target base station through a handover request message. The UE history information includes information of cells serving the UE before the target cell when the UE is in an active state. The information of cells is a list of Last Visited cells. The information of Last Visited cells includes cell Identifier (ID), a cell type, time UE stayed in the cells, cause for the handover, and/or information of Last Visited PSCells, etc. For the CHO process, after the source base station sends the RRC reconfiguration message including CHO information to the UE, the UE is still connected to the source cell. Instead of immediately performing handover, the UE will perform the process of handover to the target cell when the CHO execution condition is met for a certain cell in the candidate cell list. In this way, the time UE stayed in the source cell sent by the source base station to the target base station through the handover request message is not the actual time UE stayed in the source cell, but the actual time UE stayed in the source cell is longer. When the target cell or the cell accessed later by the UE uses the UE history information for ping-pong detection, misjudgment may be caused due to very short time UE stayed in the source cell.

For the conditional SN change process, if the existing SN change process is followed, the MN sends the UE history information to the candidate SN through the SN addition request. There are two possible errors in the UE history information sent by the MN to the candidate SN. One is the time UE stayed in the PSCell at the source SN. Because the UE is still connected to the PSCell at the source SN when receiving the RRC reconfiguration message, the UE does not disconnect from the PSCells at the source SN and access the candidate PSCell until the execution condition is met for one candidate PSCell. The above-mentioned PSCell of the UE at the source SN is the PSCell accessed by the UE at the SN when the SN change occurs. Second, the association between primary cell (Pcell) and PSCell is wrong. The MN will perform the association between the Pcell and the PSCells according to the time UE stayed in the PSCell at the SN, and will send the associated history information of the Pcell and PSCells to the candidate SN. The UE history information sent by the MN to the SN includes information of a list of Pcells accessed by the UE. The information of the Pcell includes the information of the PSCells where the UE stayed when the UE was in the Pcell. The Pcell can also be referred to be a cell, that is, a cell serving the UE at the MN.

It should be noted that, in the disclosure, the time UE stayed in a cell can be the time during which the UE stays in the cell, or can be expressed in 1/10 seconds of the time UE stayed in the cell, or can be expressed in other ways, which is not limited in this aspect.

Various embodiments of the disclosure are further described below with reference to the accompanying drawings.

The text and drawings are only provided as examples to help understand the disclosure. They should not be construed as limiting the scope of the disclosure in any way. Although some embodiments and examples have been provided, based on the disclosure herein, it is obvious to those skilled in the art that changes can be made to the illustrated embodiments and examples without departing from the scope of this disclosure.

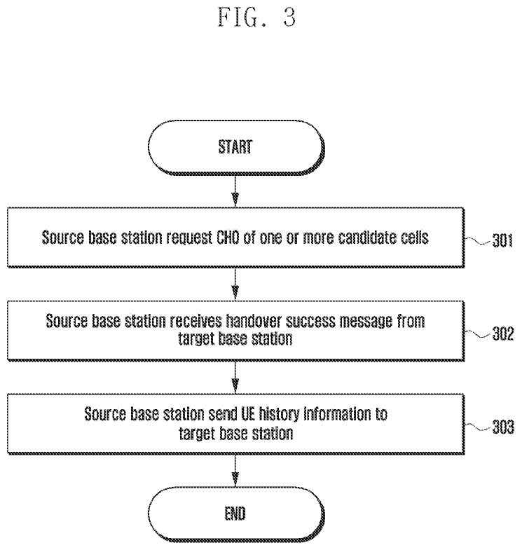

FIG. 3 shows a flowchart of a method for supporting self-configuration and self-optimization (hereinafter simply referred to as method 1) according to an embodiment of the disclosure. In this embodiment, the source base station resends UE history information to the target base station after CHO is successful.

At operation 301, the source base station requests CHO of one or more candidate cells. If there are multiple candidate cells, the candidate cells may belong to one or more candidate base stations. The source base station sends a handover request message to the candidate target base station. The handover request cell corresponds to each candidate cell. The message includes UE history information. The message may also include history information from the UE.

The source base station receives the CHO response handover request acknowledgment message from the candidate target base station. The handover request acknowledgment message is for each candidate cell.

The source base station sends an RRC reconfiguration message to the UE. The message includes the configuration of CHO candidate cells and a CHO execution condition.

At operation 302, the source base station receives a handover success message from the target base station.

At operation 303, the source base station recalculates the time UE stayed in the source cell. The time of the UE in the source cell is the time from access to the source cell by the UE to receiving the handover success message from the target base station by the source base station. When the source base station calculates the time UE stayed in the source cell, it can also be the time from access to the source cell by the UE to receiving the handover success message from the target base station by the source base station, minus the transmission delay between base stations (that is, the time for the target base station to send the handover success to the source base station). When the source base station calculates the time UE stayed in the source cell, it can also be the time from access to the source cell by the UE to receiving the handover success message from the target base station by the source base station, further minus a transmission delay between base stations and a processing delay during which the target base station forms the handover success message. The source base station can also perform other calculation methods without affecting the main content of the disclosure. The source base station sends UE history information to the target base station. The UE history information includes information of cells Last Visited by the UE. The cells Last Visited by the UE are one or more cells that served the UE in the active mode before the UE accesses the target cell. The information of cells Last Visited by the UE is one or more pieces of information. The information of the latest visited cell will be added to the top of the list. The information of cells Last Visited by the UE includes global cell Identifier, a cell type, time UE stayed in a cell, cause for the handover, and/or the list of Last Visited PSCells. The list of Last Visited PSCells is information of one or more Last Visited PSCells where the UE stayed when the UE was in the cell. The information of Last Visited PSCells includes PSCell cell Identifier and time stayed in a PSCell. The UE history information is updated with respect to the UE history information included in the handover request message. The time UE stayed in a source cell included in the UE history information is updated. Herein the source cell is one on the most top of the list of Last Visited cells in the UE history information sent to the target base station. The information of PSCells where the UE stayed when the UE was in the source cell included in the UE history information is updated, for example, the time stayed in a PSCell is updated or the list of PSCells where the UE stayed when the UE was in the source cell is updated. The source cell is a source PCell. In the UE history information included in the handover request message, the time UE stayed in the source cell is the time from access to the source cell by the UE to sending of the handover request message by the source base station. In the updated UE history information, the time UE stayed in the source cell is the time from access to the source cell by the UE to receiving the handover success message from the target base station by the source base station or successful access to a candidate target cell by the UE.

The source base station can also send the latest history information from the UE to the target base station.

The source base station can send the UE history information and/or the history information from the UE to the target base station through a serial number SN status transfer message. The source base station may also send the UE history information and/or the history information from the UE to the target base station through other messages. The UE history information is the updated UE history information. The UE history information is the updated UE history information with respect to the UE history information included in the handover request message. The UE history information from the UE is the latest UE history information received from the UE.

The target base station receives UE history information and/or history information from the UE, and the target base station updates the saved UE history information and/or history information from the UE.

As another implementation of the disclosure, the source base station may only send the information of a source cell in the UE history information to the target base station. The information of the source cell includes information such as source cell Identifier, a cell type, time UE stayed in the source cell, and/or a list of Last Visited PSCell. The list of Last Visited PSCell is information of one or more Last Visited PSCells where the UE stayed when the UE was in the source cell. The information of Last Visited PSCells includes PSCell cell Identifier and time stayed in the PSCell. The time UE stayed in the source cell is the recalculated time stayed in the source cell. The source base station can send the source cell information to the target base station through SN status transfer or other messages. In this way, after receiving the source cell information, the target base station updates (or overwrites) the source cell information in the saved UE history information received from the handover request message, and the target cell forms the updated complete UE history information.

As another implementation of the disclosure, the source base station can only send the time UE stayed in the source cell to the target base station. The time UE stayed in the source cell is the recalculated time stayed in the source cell. The source base station can send the time UE stayed in the source cell to the target base station through SN status transfer or other messages. In this way, the target base station updates the time of the UE in the source cell in the saved UE history information received from the handover request message after receiving the time UE stayed in the source cell, and the target cell forms updated complete UE history information.

The method 1 for supporting self-configuration and self-optimization of the disclosure is shown in the above by way of example. Although the method 1 is described from the perspective of the source base station, it can be understood by those skilled in the art that the target base station can perform the corresponding operation, and in order to avoid redundancy, the description thereof will not be repeated in this disclosure. With the above method 1, the misjudgment caused by inaccurate UE history information in the prior art can be avoided, and the correctness of UE history information in the CHO process can be guaranteed, so as to carry out reasonable optimization and ensure the normal operation of the system.

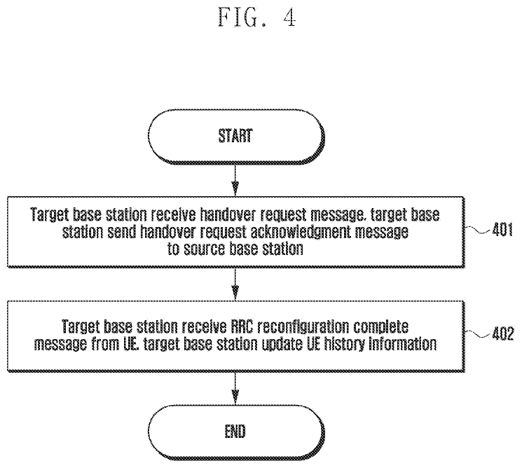

FIG. 4 shows a flowchart of a method for supporting self-configuration and self-optimization (hereinafter simply referred to as method 2) according to an embodiment of the disclosure. In this method, the target base station guarantees the correctness of UE history information.

At operation 401, a target base station receives a handover request message from a source base station. The handover request message requests CHO. The target base station is the base station to which a CHO candidate cell belongs. The handover request message includes UE history information. The handover request message may also include UE history information from the UE. The target base station saves the received UE history information. The target base station saves the received UE history information from the UE.

The target base station sends a handover request acknowledgment message to the source base station.

At operation 402, the target base station receives an RRC reconfiguration complete message from the UE.

The target base station updates the saved UE history information. The target base station updates the time UE stayed in the source cell in the saved UE history information. The UE history information saved by the target base station is received from the source base station through a handover request message. The time UE stayed in the source cell is the time UE stayed in the source cell saved by the target base station plus time X. The time X is the time duration from receiving the handover request message to receiving the RRC reconfiguration complete message by the target base station. The time X can also be the time duration from receiving the handover request message by the target base station to UE synchronization to the target cell. The time X can also be the time duration from receiving the handover request message to receiving the RRC reconfiguration complete message by the target base station minus a transmission delay between base stations (that is, the time for the source base station to send the handover request message to the target base station). The time X can also be the time duration from receiving the handover request message by the target base station to UE synchronization to the target cell minus a transmission delay between base stations (i.e., the time for the source base station to send the handover request message to the target base station). The target base station can also calculate the time X in other ways without affecting the main content of the disclosure.

So far, the method 2 for supporting self-configuration and self-optimization of the disclosure has been completed, and the method 2 for supporting self-configuration and self-optimization of the disclosure is shown in a way above. Although the method 2 is described from the perspective of the target base station, it can be understood by those skilled in the art that the source base station can perform the corresponding operation, and in order to avoid redundancy, the description thereof will not be repeated in this disclosure. With the above method 2, the misjudgment caused by inaccurate UE history information in the prior art can be avoided, and the correctness of UE history information in the CHO process can be ensured, so as to carry out reasonable optimization and ensure the normal operation of the system.

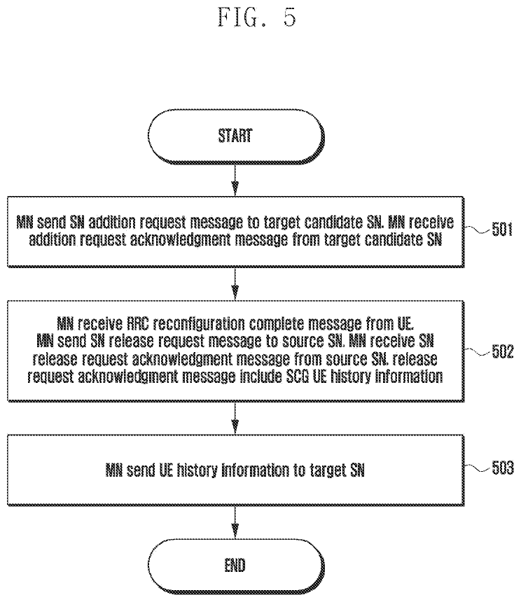

FIG. 5 shows a flowchart of a method for supporting self-configuration and self-optimization (hereinafter simply referred to as method 3) according to an embodiment of the disclosure. The embodiment can be used for the process of MN-initiated or SN-initiated conditional SN change. A detailed description of steps unrelated to the disclosure is omitted here.

At operation 501, the MN sends an SN addition request message to the target candidate SN. The SN addition request message includes UE history information. The UE history information includes a list of Last Visited cells. The information of Last Visited cells includes cell Identifier, a cell type, time UE stayed in a cell, cause for handover, and/or a list of information of Last Visited PSCells, etc. The information of PSCells includes PSCell cell Identifier and time UE stayed in the PSCell. The SN addition request message may also include UE history information from the UE. The target SN saves the received UE history information. The target SN saves the received UE history information from the UE.

The MN receives the addition request acknowledgment message from the target candidate SN.

At operation 502, the MN sends an RRC reconfiguration message to the UE. The message includes CPC configuration. The message is RRC reconfiguration*.

The MN receives an RRC reconfiguration complete message from the UE. The message is RRC reconfiguration complete**. The RRC reconfiguration complete message includes NR RRC reconfiguration complete message (RRC reconfiguration complete***) for the selected candidate PSCell. The reconfiguration completion is sent after the UE accesses one candidate target PSCell.

The MN can update the saved time UE stayed in a PS Cell at the source SN, and the PSCell of the UE at the source SN is the PSCell serving the UE at the source SN during the conditional SN change. The time UE stayed in the PSCell at the source SN is the time UE stayed in the PSCell saved by MN plus a time duration from sending of the SN addition request message to the target SN by the MN to receiving the RRC reconfiguration completion by the MN. The RRC reconfiguration complete is the RRC reconfiguration complete sent by the UE after accessing a candidate target PSCell.

The MN sends a SN release request message to the source SN.

The MN receives an SN release request acknowledgment message from the source SN. The release request acknowledgment message includes secondary cell group (SCG) UE history information. The SCG UE history information includes a list of Last Visited PSCells. The list of Last Visited PSCells includes information of one or more Last Visited PSCells. The information of Last Visited PSCells includes PSCell Identifier and the time UE stayed in the PSCell.

The MN updates the saved UE history information. The MN updates the saved history information according to the received SCG UE history information. The MN updates the time stayed in a PCell and/or the information of the accessed PSCells when the UE is in the PCell. The information of accessed PSCells includes PSCell Identifier and the time stayed in the PS Cell. Particularly, the time UE stayed in the source PSCell has been updated. Herein, the source PSCell is the most top one in the list of Last Visited PSCells in the UE history information sent to the target SN.

At operation 503, the MN sends UE history information to the target SN. The UE history information is the updated UE history information. The MN updates the UE history information according to the SCG UE history information received from the SN release request acknowledge message or the time UE stayed in the PSCell included in the SCG UE history information, and the information saved by the MN. Particularly, MN updates the time stayed in the PCell, the time stayed in the PSCell, and/or the correlation between PSCell and the PCell in the saved UE history information. Herein, the time UE stayed in the PCell changes during the conditional SN change. The time UE stayed in the source PS Cell serving the UE at the source SN changes during the conditional SN change, and the time UE stayed in the source PSCell is the time from access to the PSCell by the UE to receiving the RRC reconfiguration complete message (RRC reconfiguration complete**) by the MN. While the time UE stayed in the PS Cell sent to the target SN through the SN addition request message is the time from access to the PSCell by the UE to sending of the SN addition request message. Herein, the source PSCell is the most top one in the list of Last Visited PSCells in the UE history information sent to the target SN.

The MN can send the UE history information to the target SN through SN reconfiguration complete. The MN can also send the UE history information to the target SN through SN status transfer or other messages. The UE history information is the updated UE history information.

The MN sends the history information from the UE to the target SN. The MN can send the history information from the UE to the target SN through SN reconfiguration complete. The MN can also send the history information from the UE to the target SN through SN status transfer or other messages. The history information from the UE is the latest history information received from the UE.

The target SN saves the received UE history information and/or the history information from the UE. The target SN overwrites the previously saved UE history information with the received UE history information. The target SN overwrites the previously saved history information from the UE with the received history information from the UE.

As another implementation of the disclosure, when the association relationship between the PCell and the PSCells does not change, the MN may only send information of the updated source PCell and/or the information of the updated PSCells of the UE in the source PCell to the target SN. The information of the updated source PCell includes a PCell identifier and/or the time UE stayed in the PCell. The source PCell is a PCell that serves the UE in MN during the conditional SN change, the same applies as below. The information of the updated PS Cells is one or more PS Cells accessed by UE when the UE was in the source PCell. The information of the updated PSCells includes PSCell Identifier and time UE stayed in the PSCell. The updated PSCells are PSCells serving the UE at the source SN during the conditional SN change. The target SN updates the saved time stayed in the source PCell and/or information of the PSCells accessed in the source PCell. The target SN updates the saved history information of the corresponding PS Cells, that is, updates the time stayed in the PS Cell.

As another implementation of the disclosure, when the association between the PCell and the PSCells does not change, the MN may only send time UE stayed in the source PCell and/or the time UE stayed in the PSCell to the target SN. The PSCells are PSCells serving the UE at the source SN during the conditional SN change. The target SN updates the saved time stayed in the source PCell and/or history information of the corresponding PSCells, that is, updates the time stayed in the source PCell and/or the time stayed in the PSCell.

The above method can be used in the process of MN-triggered conditional SN change or SN-triggered conditional SN change.

So far, the method 3 for supporting self-configuration and self-optimization of the disclosure has been completed, and the method 3 for supporting self-configuration and self-optimization of the disclosure is shown in a way above. Although the method 3 is described from the perspective of an MN, it can be understood by those skilled in the art that the source SN and the target candidate SN (including the target SN) can perform corresponding operations. In order to avoid redundancy, the disclosure will not repeat the description. With the above method 3, the misjudgment caused by inaccurate UE history information in the prior art can be avoided, especially the misjudgment caused by incorrect time UE stayed in the PCell and/or PSCell or incorrect association between PS Cell and PSCells, and the correctness of UE history information in CPC process can be ensured, so as to carry out reasonable optimization and ensure the normal operation of the system.

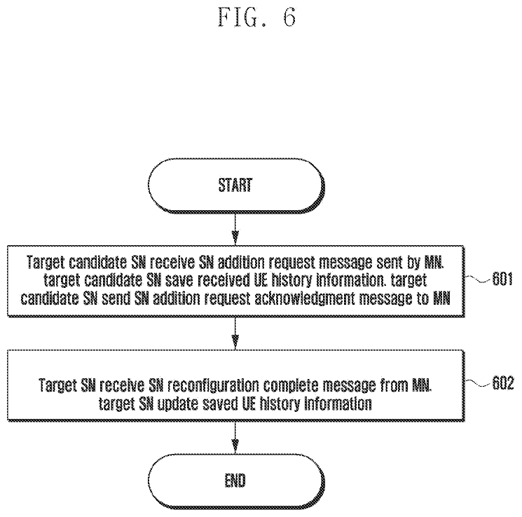

FIG. 6 shows a flowchart of a method for supporting self-configuration and self-optimization (hereinafter referred to as method 4) according to an embodiment of the disclosure. The embodiment can be used for the process of MN-initiated or SN-initiated conditional SN change. A detailed description of steps unrelated to the disclosure is omitted here.

At operation 601, the target candidate SN receives the SN addition request message sent by the MN. The SN addition request message includes UE history information. The UE history information includes a list of Last Visited cells. The information of Last Visited cells includes cell Identifier, a cell type, time UE stayed in a cell, reason for handover, and/or a list of information of Last Visited PSCells, etc. The information of PSCells includes PSCell cell Identifier and time UE stayed in the PSCell. The SN addition request message may also include UE history information from the UE. The target SN saves the received UE history information. The target SN saves the received UE history information from the UE.

The target SN sends an SN addition request acknowledgment message to the MN.

At operation 602, the target SN receives the SN reconfiguration complete message from the MN. The SN reconfiguration complete message includes UE history information and/or history information from the UE. The UE history information and/or history information from the UE is the updated UE history information and/or history information from the UE. The target SN updates the saved UE history information and/or the history information from the UE. The target SN updates the time UE stayed in a source PCell, the time UE stayed in a PS Cell at the source SN, and/or the association between the PCell and PSCells in the saved UE history information. The PSCells at the source SN of the UE are the PS Cells serving the UE at the source SN when the conditional SN change is triggered. The PS Cells at the source SN of the UE are the source PSCells serving the UE at the source SN when the conditional SN change is triggered. The UE history information saved by the target SN is received from the MN through the SN addition request message. The time UE stayed in the source PCell is the time UE stayed in the source PCell saved by the target SN plus time X. The source PCell is a PCell that serves the UE in the MN during the conditional SN change. The source PCell is the latest PCell in the list of Last Visited PCells in the UE history information received from the MN in the SN addition request message by the target SN, and the latest PCell is a PCell at the top of the UE history information. The time UE stayed in a PSCell at the source SN is the time UE stayed in a PSCell at the source SN saved by the target SN plus time X. The time X is a time duration from receiving the SN addition request message to receiving the SN reconfiguration complete message by the target SN. The time X can also be a time duration from receiving the SN addition request message by the target SN to UE synchronization to the target SN. The time X can also be a time duration from receiving the SN addition request message to receiving the SN reconfiguration complete message by the target SN minus a transmission delay between base stations (that is, the time for the MN to send the SN addition request message to the target SN). The time X can also be a time duration from receiving the SN addition request message by the target SN to UE synchronization to the cell of the target SN minus a transmission delay between base stations (i.e., the time for the MN to send the SN addition request message to the target SN). The target SN can also calculate the time X in other ways without affecting the main content of the disclosure. The RRC reconfiguration complete message is a reconfiguration complete message sent after the UE accesses a candidate target PSCell.

The MN also needs to update the UE history information saved by the MN. The MN updates the time UE stayed in the source PCell and/or in a PS Cell at the source SN in the saved UE history information. The MN can also update the association relationship between the PCell and PSCells. The PSCells at the source SN of the UE are the PSCells at the source SN serving the UE when the conditional SN change is triggered. The time UE stayed in the source PCell is the time UE stayed in the source PCell saved by MN plus time Y. The time UE stayed in a PSCell at the source SN is the time UE stayed in a PSCell at the source SN saved by MN plus time Y. The time Y is a time duration from sending of the SN addition request message to the target SN to receiving the RRC reconfiguration complete message (RRC reconfiguration complete**) by the MN. The RRC reconfiguration complete message is a reconfiguration complete message sent after the UE accesses one candidate target PSCell. The time Y may also be a time duration from sending of the RRC reconfiguration message to the UE to receiving the RRC reconfiguration complete message (RRC reconfiguration complete**) by the MN. The time Y can also be a time duration from sending of the RRC reconfiguration message to the UE to sending of the SN reconfiguration to the target SN by the MN. The time Y may also be the time duration from sending of the SN addition request message to the target SN to sending of SN reconfiguration to the target SN by the MN. The MN can also calculate the time Y in other ways without affecting the main content of the disclosure. The MN updates the association relationship between the PCell and the PSCells according to the time UE stayed in a PSCell at the source SN. The time UE stayed in a PSCell at the source SN is the updated time stayed.

The MN also receives SCG UE history information from the source SN via the SN release request acknowledgment message. The SCG UE history information is the updated SCG UE history information. The information included in the SCG UE history information is the same as that in operation 502, which will not be repeated here. The MN can update the UE history information according to the received SCG UE history information and the information saved by the MN.

The above method can be used in the process of MN-triggered conditional SN change or SN-triggered conditional SN change.

So far, the method 4 for supporting self-configuration and self-optimization of the disclosure has been completed, and the method 4 for supporting self-configuration and self-optimization of the disclosure is shown in a way above. Although the method 4 is described from the perspective of the target SN, it can be understood by those skilled in the art that the MN and the source SN can perform corresponding operations, and in order to avoid redundancy, the description thereof will not be repeated in this disclosure. With the above method 4, the misjudgment caused by inaccurate UE history information in the prior art can be avoided, especially the misjudgment caused by incorrect time UE stayed in a PCell and/or in a PSCell or incorrect association relationship between the PCell and PSCells, and the correctness of UE history information in CPC process can be ensured, so as to carry out reasonable optimization and ensure the normal operation of the system.

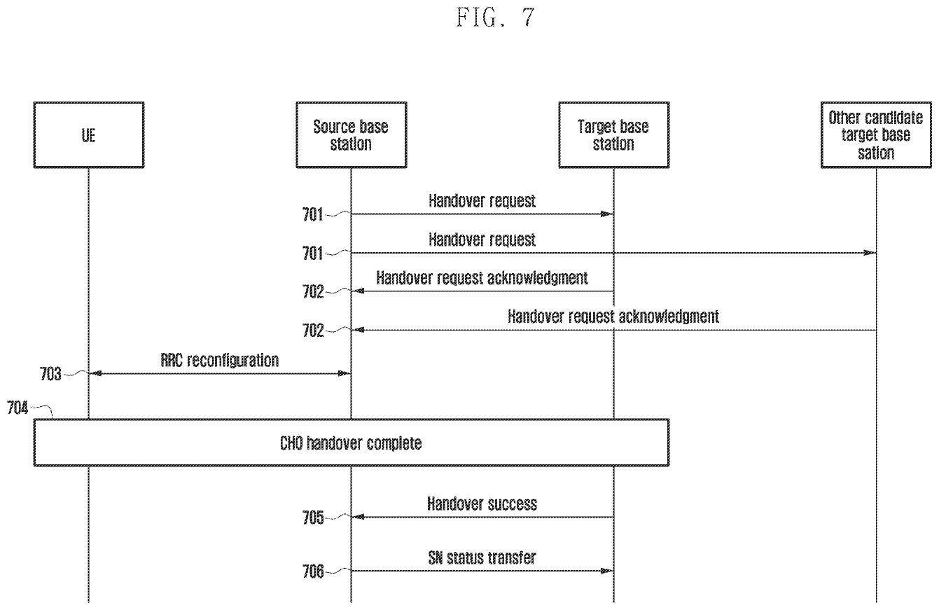

FIG. 7 shows a schematic diagram of one embodiment of method 1 for supporting self-configuration and self-optimization according to an embodiment of the disclosure. In this embodiment, the source base station resends UE history information to the target base station after CHO is successful. FIG. 7 omits and simplifies the detailed description of steps unrelated to the disclosure.

At operation 701, the source base station requests CHO of one or more candidate cells. If there are multiple candidate cells, the multiple candidate cells may belong to one or more candidate base stations. The source base station sends a handover request message to the candidate target base station. The handover request cell corresponds to each candidate cell. The message includes UE history information. The message may also include history information from the UE.

At operation 702, the source base station receives the CHO response handover request acknowledgment message from the candidate target base station. The handover request acknowledgment message is for each candidate cell.

At operation 703, the source base station sends an RRC reconfiguration message to the UE. The message includes the configuration of CHO candidate cells and the CHO execution condition. The source base station receives the RRC reconfiguration complete message from the UE.

At operation 704, if at least one CHO candidate cell meets the corresponding CHO execution condition, the UE leaves the source base station, and uses the saved corresponding configuration of the selected candidate cell to synchronize to the candidate cell and send an RRC reconfiguration complete to the target base station.

At operation 705, the source base station receives a handover success message from the target base station.

The source base station recalculates the time UE stayed in a source cell. The time of the UE in a source cell is the time from access to the source cell by the UE to receiving the handover success message from the target base station by the source base station. When the source base station calculates the time UE stayed in a source cell, it can also be the time from access to the source cell by the UE to receiving the handover success message from the target base station by the source base station, minus a transmission delay between base stations (that is, the time for the target base station to send the handover success to the source base station). When the source base station calculates the time UE stayed in the source cell, it can also be the time from access to the source cell by the UE to receiving the handover success message from the target base station by the source base station, minus the transmission delay between base stations and a processing delay during which the target base station forms the handover success message. The base station can also use other calculation methods without affecting the main content of the disclosure.

At operation 706, the source base station sends the SN status transfer to the target base station. The source base station sends UE history information to the target base station through the SN status transfer message. The source base station can also send UE history information to the target base station through other messages. The UE history information is the UE history information updated in operation 705.

The UE history information is updated with respect to the UE history information included in the handover request message. The time UE stayed in a source cell included in the UE history information is updated. In the UE history information included in the handover request message, the time UE stayed in a source cell is the time from access to the source cell by the UE to sending of the handover request message by the source base station.

The source base station can also send the history information from the UE to the target base station. The history information from the UE is the latest history information from the UE received from the UE. The source base station may also send the latest history information from the UE to the target base station in this step in case that the history information from the UE is changed with respect to the history information from the UE sent to the target base station in operation 701.

The target base station receives UE history information and/or history information from the UE, and the target base station updates the saved UE history information and/or history information from the UE.

As another implementation of the disclosure, the source base station may only send the information of the source cell in the UE history information to the target base station. The information of the source cell includes information such as source cell Identifier, a cell type, time UE stayed in a source cell, and/or a list of information of PSCells accessed by the UE in the source cell. The time UE stayed in a source cell is the above recalculated time stayed in the source cell. The source base station can send the source cell information to the target base station through SN status transfer or other messages. In this way, after receiving the source cell information, the target base station updates (or overwrites) the saved source cell information in the UE history information received from the handover request message, and the target cell forms the updated complete UE history information.

As another implementation of the disclosure, the source base station can only send the time UE stayed in a source cell to the target base station. The time UE stayed in a source cell is the above recalculated time stayed in a source cell. The source base station can send the time UE stayed in a source cell to the target base station through SN status transfer or other messages. In this way, the target base station updates the time of the UE in a source cell in the saved UE history information received from the handover request message after the time of the UE in the source cell is received, and the target cell forms the updated complete UE history information.

The description of an embodiment of the method 1 for supporting self-configuration and self-optimization of the disclosure is shown in a way. With this method, the misjudgment caused by inaccurate UE history information in the prior art can be avoided, and the correctness of UE history information in the CHO process can be ensured, so as to carry out reasonable optimization and ensure the normal operation of the system.

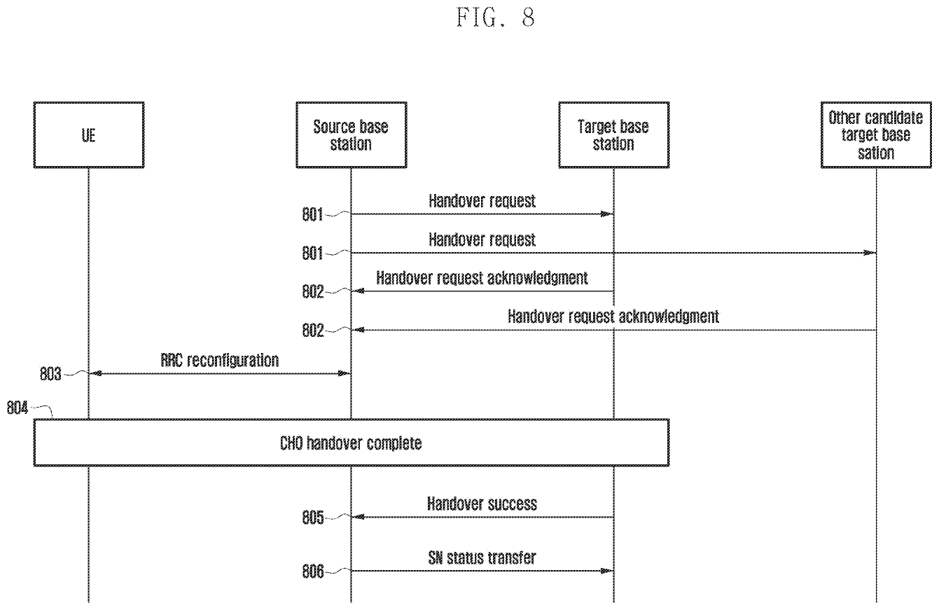

FIG. 8 shows a schematic diagram of an embodiment of method 2 for supporting self-configuration and self-optimization according to an embodiment of the disclosure. In this embodiment, the target base station updates the saved UE history information. FIG. 8 omits and simplifies the detailed description of steps unrelated to the disclosure.

Operations 801 to 803 are the same as operations 701 to 703, and the operations are not repeated here.

At operation 804, if at least one CHO candidate cell meets the corresponding CHO execution condition, the UE leaves the source base station, uses the saved corresponding configuration of the selected candidate cell, synchronizes to the candidate cell, and sends RRC reconfiguration complete to the target base station.

The target base station updates the saved UE history information. The target base station updates the time UE stayed in the source cell in the saved UE history information. The UE history information saved by the target base station is received from the source base station through a handover request message. The time UE stayed in the source cell is the time UE stayed in the source cell saved by the target base station plus time X. The time X is a time duration from receiving the handover request message to receiving the RRC reconfiguration complete message by the target base station. The time X can also be a time duration from receiving the handover request message by the target base station to UE synchronization to the target cell. The time X can also be a time duration from receiving the handover request message to receiving the RRC reconfiguration complete message by the target base station minus a transmission delay between base stations (that is, the time for the source base station to send the handover request message to the target base station). The time X can also be the time duration from receiving the handover request message by the target base station to UE synchronization to the target cell minus the transmission delay between base stations (i.e., the time for the source base station to send the handover request message to the target base station). The target base station can also calculate the time X in other ways without affecting the main content of the disclosure.

At operation 805, the target base station sends a handover success message to the source base station.

At operation 806, the source base station sends an SN status transfer to the target base station.

The description of an embodiment of the method 2 for supporting self-configuration and self-optimization of the disclosure is shown in the above by way of example. With this method, the misjudgment caused by inaccurate UE history information in the prior art can be avoided, and the correctness of UE history information in the CHO process can be ensured, so as to carry out reasonable optimization and ensure the normal operation of the system.

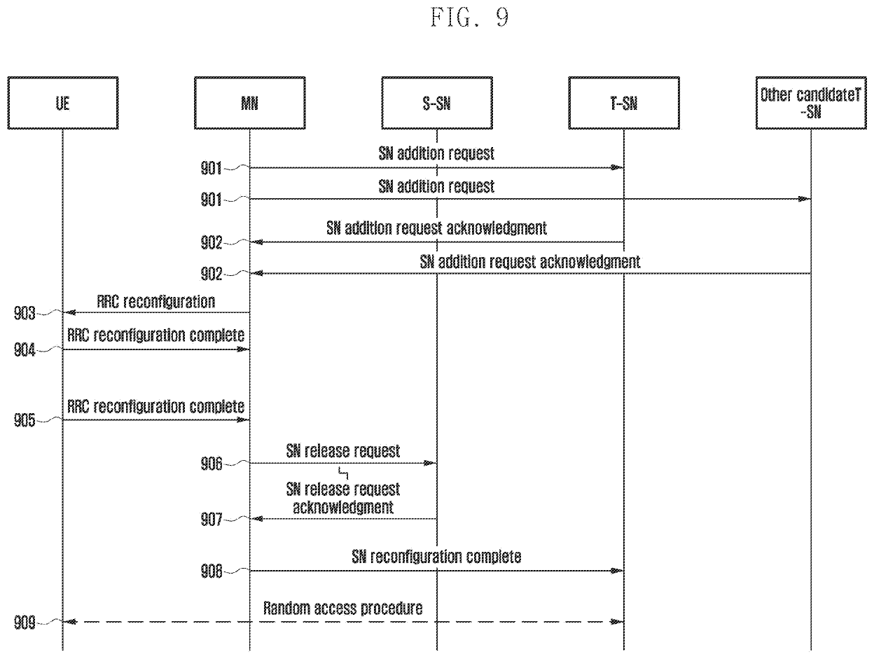

FIG. 9 shows a schematic diagram of an embodiment of method 3 for supporting self-configuration and self-optimization according to an embodiment of the disclosure. FIG. 9 omits and simplifies the detailed description of operations unrelated to the disclosure. The embodiment can be used for the process of MN-initiated or SN-initiated conditional SN change. Here, the MN-initiated conditional SN change is taken as an example.

At operation 901, the MN sends an SN addition request message to the target candidate SN. The SN addition request message includes UE history information. The UE history information includes the same information as that in operation 501, which will not be described here. The SN addition request message may also include UE history information from the UE. The target SN saves the received UE history information. The target SN saves the received UE history information from the UE.

At operation 902, the MN receives an addition request acknowledgment message from the target candidate SN.

At operation 903, the MN sends an RRC connection reconfiguration message to the UE. The message includes CPC configuration. The RRC connection reconfiguration message is RRC connection reconfiguration* in TS37.340, and includes MN RRC connection reconfiguration* * and SN RRC reconfiguration***. The specific meaning of RRC connection reconfiguration*, MN RRC connection reconfiguration** and SN RRC reconfiguration*** are the same as those in TS37.340.

At operation 904, the MN receives an RRC connection reconfiguration complete message from the UE. The RRC connection reconfiguration complete message is the RRC connection reconfiguration* in the TS37.340, and indicates that the UE has completed RRC configuration except CPC configuration.

At operation 905, the MN receives the RRC reconfiguration complete message from the UE. The message is the RRC reconfiguration complete** in TS37.340. The RRC reconfiguration complete message includes NR RRC reconfiguration complete message (RRC reconfiguration complete***) for the selected candidate PSCell and the information of the selected PSCell.

At operation 906, the MN sends an SN release request message to the source SN.

At operation 907, the MN receives an SN release request acknowledgment message from the source SN. The release request acknowledgment message includes secondary cell group (SCG) UE history information. The SCG UE history information includes a list of Last Visited PSCells. The list of Last Visited PSCells includes information of one or more Last Visited PSCells. The information of the Last Visited PSCells includes PSCell Identifier and time UE stayed in a PSCell.

The MN updates the saved UE history information. The MN updates the saved UE history information according to the received SCG UE history information and/or the information saved by the MN.

The MN updates the UE history information according to the SCG UE history information received from the SN release request acknowledge message or the time UE stayed in a PSCell included in the SCG UE history information. Particularly, the MN updates the time stayed in a PCell, the time stayed in a PSCell, and/or the correlation between PSCells and the PCell in the saved UE history information. The time UE stayed in a source PSCell serving the UE at the source SN changes during the conditional SN change, and the time UE stayed in a source PSCell is the time from access to the PSCell by the UE to receiving the RRC reconfiguration complete message (RRC reconfiguration complete**) by the MN. While the time UE stayed in a PSCell sent to the target SN through the SN addition request message is the time from access to the PSCell by the UE to sending of the SN addition request message. Wherein, the time UE stayed in the source PCell changes during the conditional SN change, and the time UE stayed in the source PCell is the time from access to the source PCell by the UE to receiving the RRC reconfiguration complete message (RRC reconfiguration complete * *) by the MN. And the time UE stayed in the source PCell sent to the target SN through the SN addition request message is the time from access to the source PCell to sending the SN addition request message by the UE. The RRC reconfiguration complete message is a reconfiguration complete message sent after the UE accesses a candidate target PSCell.

At operation 908, the MN sends an SN reconfiguration complete message to the target SN. The message includes UE history information. The message may also include UE information from the UE. The MN can also send the UE history information and/or the history information from the UE to the target SN through other messages. The UE history information is the updated UE history information. The history information from the UE is the latest history information from the UE received from the UE. The MN may also send the latest history information from the UE to the target base station in this step in case that the history information from the UE is changed with respect to the history information from the UE sent to the target SN in operation 901.

The MN can send the UE history information and/or the history information from the UE to the target SN through SN reconfiguration complete. The MN may also send the UE history information and/or the history information from the UE to the target SN through SN status transfer or other messages.

The target SN saves the received UE history information and/or the history information from the UE. The target SN overwrites the previously saved UE history information with the received UE history information. The target SN overwrites the previously saved history information from the UE with the received history information from the UE.

As another implementation of the disclosure, when the association relationship between the PCell and the PSCells does not change, the MN may only send the information of the updated PCell and/or the information of the updated PSCells in the PCell to the target SN. The information of the updated PCell includes PCell identifier and/or time UE stayed in the PCell. The information of the updated PSCells is information of one or more PSCells where the UE stayed in the PCell. The information of the updated PS Cell includes PSCell Identifier and time UE stayed in a PSCell. The updated PSCells are PSCells serving the UE at the source SN during the conditional SN change. The PSCell is also the source PS Cell. The target SN updates the saved time stayed in the PCell and/or history information in the corresponding PS Cell, that is, updates the time stayed in the PSCell.

As another implementation of the disclosure, when the association relationship between the PCell and the PSCells does not change, the MN may only send the time stayed in the source PCell and/or the time UE stayed in a PSCell to the target SN. The PSCell is a PSCell serving the UE at the source SN during the conditional SN change. The PSCell is also the source PSCell. The target SN updates the saved time stayed in the source PCell and/or history information of the corresponding PSCell, that is, updates the time stayed in the source PCell and/or the time stayed in the PSCell.

At operation 909, if the configured bearer needs SCG radio resources, the UE synchronizes to the target SN by performing a random access procedure.

The above method can be used in the process of MN-triggered conditional SN change or SN-triggered conditional SN change.

So far, the description of an embodiment of the method 3 for supporting self-configuration and self-optimization of the disclosure has been completed, and the description of the embodiment of the method 3 for supporting self-configuration and self-optimization of the disclosure is shown in a way as above. With the above method, the misjudgment caused by inaccurate UE history information in the prior art can be avoided, especially the misjudgment caused by incorrect time UE stayed in a PSCell or incorrect association between PSCells and the PCell, and the correctness of UE history information in CPC process can be ensured, so as to carry out reasonable optimization and ensure the normal operation of the system.

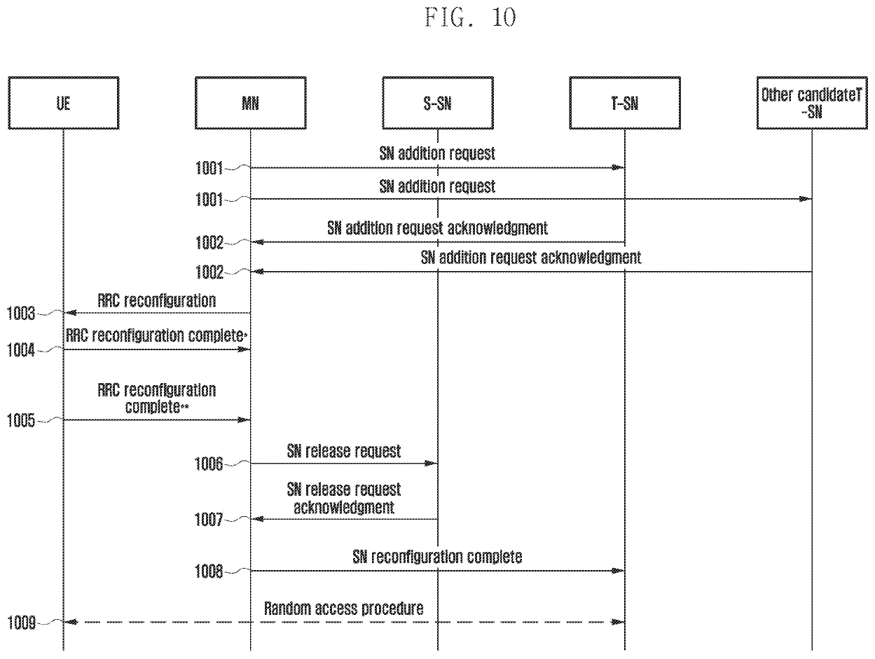

FIG. 10 shows a schematic diagram of an embodiment of the method 4 for supporting self-configuration and self-optimization according to an embodiment of the disclosure. FIG. 10 omits and simplifies the detailed description of operations unrelated to the disclosure. The embodiment can be used for the process of MN-initiated or SN-initiated conditional SN change. Here, the MN-initiated conditional SN change is taken as an example.

At operation 1001, the MN sends an SN addition request message to the target candidate SN. And the SN addition request message includes UE history information. The information included in the UE history information is the same with those in operation 601, which will not be described here. The SN addition request message may also include UE history information from the UE. The target SN saves the received UE history information. The target SN saves the received UE history information from the UE.

At operation 1002, the MN receives an addition request acknowledgment message from the target candidate SN.

At operation 1003, the MN sends an RRC connection reconfiguration message to the UE. The message includes CPC configuration. The RRC connection reconfiguration message is RRC connection reconfiguration* in TS37.340, and includes MN RRC connection reconfiguration* * and SN RRC reconfiguration***. The specific meaning of RRC connection reconfiguration*, MN RRC connection reconfiguration** and SN RRC reconfiguration*** are the same as those in TS37.340.

At operation 1004, the MN receives an RRC connection reconfiguration complete message from the UE. The RRC connection reconfiguration complete message is the RRC connection reconfiguration* in the TS37.340, and indicates that the UE has completed the RRC configuration except the CPC configuration.

At operation 1005, the MN receives the RRC reconfiguration complete message from the UE. The message is RRC reconfiguration complete** in TS37.340. The RRC reconfiguration complete message includes NR RRC reconfiguration complete message (RRC reconfiguration complete***) for the selected candidate PSCell and the information of the selected PSCell.

The MN updates the saved UE history information. The MN updates the time UE stayed in a source SN PSCell in the saved UE history information. The PSCell at the source SN of the UE is the PSCell serving the UE at the source SN when conditional SN change is triggered. The MN also updates the association relationship between the PCell and PSCells. The method for updating by the MN is the same as that in operation 602, and will not be described here.

At operation 1006, the MN sends an SN release request message to the source SN.

At operation 1007, the MN receives an SN release request acknowledgment message from the source SN. The release request acknowledgment message includes secondary cell group (SCG) UE history information. And the SCG UE history information includes a list of Last Visited PSCells. The information of the Last Visited PSCells includes PSCell Identifier and the time UE stayed in a PSCell.

The MN updates the saved UE history information. The MN updates the saved history information according to the received SCG UE history information.

The MN updates the UE history information according to the SCG UE history information received from the SN release request acknowledge message or the time UE stayed in a PSCell included in the SCG UE history information. Particularly, MN updates the time stayed in a PSCell and/or the correlation between PSCells and the PCell in the saved UE history information. The time UE stayed in a PSCell serving the UE at the source SN changes during the conditional SN change, which is the time from access to the PSCell by the UE to receiving the RRC reconfiguration complete message (RRC reconfiguration complete**) by the MN. While the time UE stayed in a PSCell sent to the target SN through the SN addition request message is the time from access to the PSCell by the UE to sending of the SN addition request message. The specific method for the MN to update the saved UE history information is the same as that in operation 602, and will not be described here.

At operation 1008, the MN sends a SN reconfiguration complete message to the target SN.

The target SN updates the saved UE history information. The target SN updates the time UE stayed in a source PCell and/or the time UE stayed in a PSCell at the source SN in the saved UE history information. The PSCell of the UE at the source SN is a PSCell serving the UE at the source SN when the conditional SN change is triggered. The PSCell is a source PSCell. The UE history information saved by the target SN is received from the MN through the SN addition request message. The time UE stayed in a source PCell is the time UE stayed in a source PCell saved by the target SN plus time X. The time UE stayed in a PSCell at the source SN is the time UE stayed in a PSCell at the source SN saved by the target SN plus time X. The time X is a time duration from receiving the SN addition request message to receiving the SN reconfiguration complete message by the target SN. The time X can also be a time duration from receiving the SN addition request message by the target SN to UE synchronization to the target SN. The time X can also be a time duration from receiving the SN addition request message to receiving the SN reconfiguration complete message by the target SN minus a transmission delay between base stations (that is, the time for the MN to send the SN addition request message to the target SN). The time X can also be a time duration from receiving the SN addition request message by the target SN to UE synchronization to the cell of the target SN minus the transmission delay between base stations (i.e., the time for the MN to send the SN addition request message to the target SN). The target SN can also calculate the time X in other ways without affecting the main content of the disclosure.

At operation 1009, if the configured bearer needs SCG radio resources, the UE synchronizes to the target SN by performing a random access procedure.

The above method can be used in the process of the MN-initiated conditional SN change or SN-initiated conditional SN change.

So far, the description of the embodiment of the method 4 for supporting self-configuration and self-optimization of the disclosure has been completed, and the description of the embodiment of the method 4 for supporting self-configuration and self-optimization of the disclosure is shown in a way as above. With the above method, the misjudgment caused by inaccurate UE history information in the prior art can be avoided, especially the misjudgment caused by incorrect time UE stayed in a PCell or a PSCell or incorrect association between PSCells and the PCell, and the correctness of UE history information in CPC process can be ensured, so as to carry out reasonable optimization and ensure the normal operation of the system.

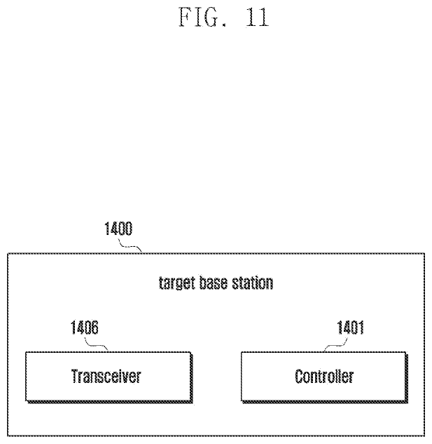

FIG. 11 shows a block diagram of a target base station according to an embodiment of the disclosure.

Referring to FIG. 11, the target base station 1400 may include a controller 1401 and a transceiver 1406. According to the embodiment of the disclosure, the controller 1401 can be defined as a circuit-specific integrated circuit or at least one processor. The controller 1401 can control the overall operation of the target base station and control the target base station to implement various methods proposed in the disclosure.

Transceiver 1406 can send/receive signals to/from other network entities (such as but not limited to a source base station, a third base station, a user equipment) by wired or wireless. For example, the transceiver 1406 may send and receive signals to and from the user equipment.

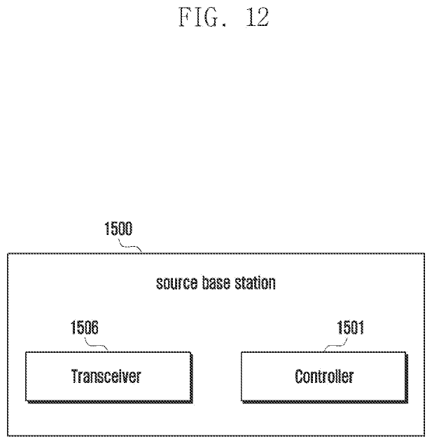

FIG. 12 shows a block diagram of a source base station according to an embodiment of the disclosure.

Referring to FIG. 12, a source base station 1500 may include a controller 1501 and a transceiver 1506. According to the embodiment of the disclosure, the controller 1501 can be defined as a circuit-specific integrated circuit or at least one processor. The controller 1501 can control the overall operation of the source base station and control the source base station to implement various methods proposed in the disclosure.

Transceiver 1506 can send/receive signals to/from other network entities (such as but not limited to a target base station, a third base station, a user equipment) by wired or wireless. For example, the transceiver 1506 may send and receive signals to and from the user equipment.

Those skilled in the art will understand that various illustrative logical blocks, modules, circuits, and steps described in this application can be implemented as hardware, software, or combinations of both. To clearly illustrate this interchangeability between hardware and software, various illustrative components, blocks, modules, circuits, and steps are generally described above in the form of their functional sets. Whether such a function set is implemented as hardware or software depends on the specific application and the design constraints imposed on the overall system. Technicians can implement the described set of functions in different ways for each specific application, but such design decisions should not be interpreted as causing a departure from the scope of this application.

The various illustrative logic blocks, modules, and circuits described in this application can be implemented or performed with a general purpose processor, a digital signal processor (DSP), an application specific integrated circuit (ASIC), a field programmable gate array (FPGA) or other programmable logic devices, discrete gate or transistor logic, discrete hardware components, or any combination thereof designed to perform the functions described herein. The general-purpose processor may be a microprocessor, but in the alternative, the processor may be any conventional processor, controller, microcontroller, or state machine. The processor can also be implemented as a combination of computing devices, such as a combination of a DSP and a microprocessor, a plurality of microprocessors, one or more microprocessors cooperating with a DSP core, or any other such configuration.

The steps of the method or algorithm described in this application can be directly embodied in hardware, in a software module performed by a processor, or in a combination of the both. The software modules may reside in random access memory (RAM) memory, flash memory, read only memory (ROM) memory, erasable programmable ROM (EPROM) memory, electrically EPROM (EEPROM) memory, registers, hard disks, removable disks, or any other form of storage media known in the art. A storage medium is coupled to the processor so that the processor can read and write information from/to the storage medium. In the alternative, the storage medium may be integrated into the processor. The processor and the storage medium may reside in the ASIC. The ASIC may reside in the user terminal In the alternative, the processor and the storage medium may reside as discrete components in the user terminal.

In one or more designs, the functions can be implemented in hardware, software, firmware, or any combination thereof. If implemented in software, each function can be saved on or transmitted by a computer-readable medium as one or more instructions or codes. Computer readable media include both computer storage media and communication media, the latter including any media that facilitates the transfer of computer programs from one place to another. Storage media can be any available media that can be accessed by general-purpose or special-purpose computers.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a source base station in a wireless communication system, the method comprising;
transmitting, to at least one candidate target base station, a handover request message for requesting a conditional handover (CHO), the handover request message including a user equipment (UE) history information;
receiving, from a target base station among the at least one candidate target base station, a handover request acknowledgment message as a response to the handover request message;
transmitting, to a UE, a radio resource control (RRC) reconfiguration message for the CHO; and
in case that the CHO is completed, receiving, from the target base station, a handover success message,
wherein a value of a time UE stayed in a cell of the source base station included in the UE history information is updated based on the CHO.

2. The method of claim 1,
wherein a connection between the UE and the source base station is maintained after transmission of the RRC reconfiguration message for the CHO, and
wherein, in case that a condition for the CHO is satisfied, the CHO is performed.

3. The method of claim 2,
wherein the UE history information includes a cell identifier (ID), and
wherein the RRC reconfiguration message includes the condition for the CHO and a configuration of CHO candidate cells.

4. The method of claim 1, wherein the updated value of the time UE stayed in cell of the source base station is equal to the value included in the UE history information plus a time duration from reception of the handover request message transmitted from the source base station to reception of an RRC reconfiguration complete message transmitted form the UE.

5. A method performed by a target base station in a wireless communication system, the method comprising:
receiving, from a source base station, a handover request message for requesting a conditional handover (CHO), the handover request message including a user equipment (UE) history information;
transmitting, to the source base station, a handover request acknowledgment message as a response to the handover request message;
in case that the CHO is completed, receiving, from a UE, a radio resource control (RRC) reconfiguration complete message for the CHO; and
transmitting, to the source base station, a handover success message as a response to the RRC reconfiguration complete message,
wherein a value of a time UE stayed in a cell of the source base station included in the UE history information is updated based on the CHO.

6. The method of claim 5,
wherein a connection between the UE and the source base station is maintained after transmission of the RRC reconfiguration message for the CHO, and
wherein, in case that a condition for the CHO is satisfied, the CHO is performed.

7. The method of claim 6,
wherein the UE history information includes a cell identifier (ID), and
wherein the RRC reconfiguration message includes the condition for the CHO and a configuration of CHO candidate cells.

8. The method of claim 5, wherein the updated value of the time UE stayed in cell of the source base station is equal to the value included in the UE history plus a time duration from receiving the handover request message transmitted from the source base station to receiving the RRC reconfiguration complete message transmitted from the UE.

9. A source base station in a wireless communication system, the source base station comprising:
a transceiver; and
a controller coupled with the transceiver and configured to:
transmit, to at least one candidate target base station, a handover request message for requesting a conditional handover (CHO), the handover request message including a user equipment (UE) history information,
receive, from a target base station among the at least one candidate target base station, a handover request acknowledgment message as a response to the handover request message,
transmit, to a UE, a radio resource control (RRC) reconfiguration message for the CHO, and
in case that the CHO is completed, receive, from the target base station, a handover success message,
wherein a value of a time UE stayed in a cell of the source base station included in the UE history information is updated based on the CHO.

10. The source base station of claim 9,
wherein a connection between the UE and the source base station is maintained after transmission of the RRC reconfiguration message for the CHO, and
wherein, in case that a condition for the CHO is satisfied, the CHO is performed.

11. The source base station of claim 10,
wherein the UE history information includes a cell identifier (ID), and
wherein the RRC reconfiguration message includes the condition for the CHO and a configuration of CHO candidate cells.

12. The source base station of claim 9, wherein the updated value of the time UE stayed in cell of the source base station is equal to the value included in the UE history information plus a time duration from reception of the handover request message transmitted from the source base station to reception of an RRC reconfiguration complete message transmitted form the UE.

13. A target base station in a wireless communication system, the target base station comprising:
a transceiver; and
a controller coupled with the transceiver and configured to:
receive, from a source base station, a handover request message for requesting a conditional handover (CHO), the handover request message including a user equipment (UE) history information,
transmit, to the source base station, a handover request acknowledgment message as a response to the handover request message,
in case that the CHO is completed, receive, from a UE, a radio resource control (RRC) reconfiguration complete message for the CHO, and
transmit, to the source base station, a handover success message as a response to the RRC reconfiguration complete message,
wherein a value of a time UE stayed in a cell of the source base station included in the UE history information is updated based on the CHO.

14. The target base station of claim 13,
wherein a connection between the UE and the source base station is maintained after transmission of the RRC reconfiguration message for the CHO, and
wherein, in case that a condition for the CHO is satisfied, the CHO is performed.

15. The target base station of claim 14,
wherein the UE history information includes a cell identifier (ID), and
wherein the RRC reconfiguration message includes the condition for the CHO and a configuration of CHO candidate cells.

16. The target base station of claim 13, wherein the updated value of the time UE stayed in cell of the source base station is equal to the value included in the UE history plus a time duration from receiving the handover request message transmitted from the source base station to receiving the RRC reconfiguration complete message transmitted from the UE.
